(19) United States
(12) Patent Application Publication
(10) Pub. No.: US 2019/0370293 A1
(43) Pub. Date: Dec. 5, 2019

(54) METHOD AND APPARATUS FOR PROCESSING INFORMATION

(71) Applicant: BEIJING BAIDU NETCOM SCIENCE AND TECHNOLOGY CO., LTD., Beijing (CN)

(72) Inventors: Mengtao WANG, Beijing (CN); Leding LI, Beijing (CN); Danfeng LU, Beijing (CN); Xuanchen DONG, Beijing (CN)

(21) Appl. No.: 16/352,524

(22) Filed: Mar. 13, 2019

(30) Foreign Application Priority Data
May 31, 2018 (CN) 201810546665.0

(51) Int. Cl. G06F 16/903; G06F 16/9035; H04L 29/08

(52) U.S. Cl. CPC G06F 16/90335; H04L 67/1021; H04L 67/1014; G06F 16/9035

(57) ABSTRACT

Embodiments of the present disclosure relate to a method and apparatus for processing information. An implementation of the method includes: filtering a target subject from received subjects according to a preset data type; importing the target subject into a pre-trained data processing model to obtain a to-be-sent subject corresponding to the target subject; and sending the to-be-sent subject to a subscriber according to a local subject subscription routing table. Some embodiments implement local processing of the target subject of the preset data type, reduce the network data transmission amount and the cloud data processing amount, and improve the data processing efficiency.

### CROSS-REFERENCE TO RELATED APPLICATIONS

This application claims priority to Chinese Patent Application No. 201810546665.0, filed with the China National Intellectual Property Administration (CNIPA) on May 31, 2018, the content of which is incorporated herein by reference in its entirety.

### TECHNICAL FIELD

Embodiments of the present disclosure relate to the field of computer technology, specifically to a method and apparatus for processing information.

### BACKGROUND

Cloud computing is an add-on, use, and delivery mode of Internet-based related services that typically involves providing dynamically, scalable and often virtualized resources through the Internet. Cloud computing has powerful data processing capability and can provide a variety of data processing services. In practice, a data processing request needs to go through layers of networks to reach the server where the cloud computing is located, and each pass of a layer of the network increases the risk of data security. In addition, most data processing requests do not require a strong data processing capability. To this end, edge computing is generated. Edge computing refers to providing near-end services nearby by adopting an open platform that integrates core capabilities such as the network, computing, storage, and applying on a side close to the object or data source. The application programs of the edge computing are launched on the edge side, resulting in faster network service response, meeting the industry's basic needs in the aspects such as real-time business, application intelligence, and security and privacy protection. Edge computing devices (i.e., devices that deploy edge computing, also known as brokers) have partial cloud computing function, thus can provide data processing services identical or similar to cloud computing. Generally, after the subscriber (i.e., the client that subscribes to subjects in an edge computing device) of an edge computing device subscribes to a certain subject to the edge computing device, when there is a publisher connected to the edge computing device (i.e., the client that sends messages to the edge computing device through the subjects) publishes a message of the subject to the edge computing device, the edge computing device may forward payload information carried by the subject to the subscriber.

### SUMMARY

Embodiments of the present disclosure provide a method and apparatus for processing information.

In a first aspect, the embodiments of the present disclosure provide a method for processing information, including: filtering a target subject from received subjects according to a preset data type; importing the target subject into a pre-trained data processing model to obtain a to-be-sent subject corresponding to the target subject, the data processing model being obtained by training by a cloud based on historical data of a current edge computing device corresponding to the preset data type, used for representing a corresponding relationship between to-be-processed historical data included in the historical data and historical result data corresponding to the to-be-processed historical data, and the historical data including the to-be-processed historical data and the historical result data corresponding to the to-be-processed historical data; and sending the to-be-sent subject to a subscriber according to a local subject subscription routing table.

In some embodiments, the method includes: setting an input end address of the data processing model as a receiving address of the target subject; and setting an output end address of the data processing model as a sending address of the to-be-sent subject.

In some embodiments, the importing the target subject into a pre-trained data processing model includes: querying, in the local subject subscription routing table, primary routing information between a publisher address corresponding to the target subject and the input end address of the data processing model, where the local subject subscription routing table is for recording the publisher address and a subscriber address corresponding to the target subject; and sending the target subject from the publisher address to an input end of the data processing model based on the primary routing information.

In some embodiments, the importing the target subject into a pre-trained data processing model includes: querying, in response to the data processing model obtaining the to-be-sent subject, a subscriber address of the target subject corresponding to the to-be-sent subject; querying, in the local subject subscription routing table, secondary routing information corresponding to an output end address of the data processing model and the subscriber address; and sending the to-be-sent subject from an output end of the data processing model to the subscriber based on the secondary routing information.

In some embodiments, the sending the to-be-sent subject to a subscriber according to a local subject subscription routing table further includes: sending the to-be-sent subject to the cloud, in response to the local subject subscription routing table not including the subscriber corresponding to the to-be-sent subject.

In a second aspect, the embodiments of the present disclosure provide a method for processing information, including: sorting historical data according to a preset data type to obtain at least one data set, the historical data being from a same edge computing device, including to-be-processed historical data and historical result data corresponding to the to-be-processed historical data; training, for a data set in the at least one data set, to obtain a data processing model corresponding to the data set based on historical data in the data set, and the data processing model being used to represent a corresponding relationship between to-be-processed historical data included in the historical data and historical result data corresponding to the to-be-processed historical data in the data set; and sending the data processing model to the edge computing device corresponding to the historical data.

In some embodiments, the method further includes: receiving a to-be-sent subject, where the to-be-sent subject is generated by the data processing model on the edge computing device; and sending the to-be-sent subject to a subscriber according to a cloud subject subscription routing table, where the cloud subject subscription routing table is used to record a subscriber address subscribing to the to-be-sent subject.

In a third aspect, the embodiments of the present disclosure provide an apparatus for processing information, including: a target subject acquisition unit, configured to filter a target subject from received subject according to a preset data type; a to-be-sent subject acquisition unit, configured to import the target subject into a pre-trained data processing model to obtain a to-be-sent subject corresponding to the target subject, the data processing model being obtained by training by a cloud based on historical data of a current edge computing device corresponding to the preset data type, for representing a corresponding relationship between to-be-processed historical data included in the historical data and historical result data corresponding to the to-be-processed historical data, and the historical data including the to-be-processed historical data and the historical result data corresponding to the to-be-processed historical data; and a first sending unit, configured to send the to-be-sent subject to a subscriber according to a local subject subscription routing table.

In some embodiments, the apparatus further includes: a first address setting unit, configured to set an input end address of the data processing model as a receiving address of the target subject; and a second address setting unit, configured to set an output end address of the data processing model as a sending address of the to-be-sent subject.

In some embodiments, the to-be-sent subject acquisition unit includes: a primary routing information querying subunit, configured to query, in the local subject subscription routing table, primary routing information between a publisher address corresponding to the target subject and the input end address of the data processing model, where the local subject subscription routing table is for recording the publisher address and a subscriber address corresponding to the target subject; and a first information sending subunit, configured to send the target subject from the publisher address to an input end of the data processing model based on the primary routing information.

In some embodiments, the to-be-sent subject acquisition unit includes: a primary routing information querying subunit, configured to query, in the local subject subscription routing table, primary routing information between a publisher address corresponding to the target subject and the input end address of the data processing model, where the local subject subscription routing table is for recording the publisher address and a subscriber address corresponding to the target subject; and a first information sending subunit, configured to send the target subject from the publisher address to an input end of the data processing model based on the primary routing information.

In some embodiments, the first sending subunit includes: a subscription address querying subunit, configured to query, in response to the data processing model obtaining the to-be-sent subject, a subscriber address of the target subject corresponding to the to-be-sent subject; a secondary routing information querying subunit, configured to query, in the local subject subscription routing table, secondary routing information corresponding to an output end address of the data processing model and the subscriber address; and a second information sending subunit, configured to send the to-be-sent subject from an output end of the data processing model to the subscriber based on the secondary routing information.

In some embodiments, the first sending unit further includes: a third information sending subunit, configured to send the to-be-sent subject to the cloud, in response to the local subject subscription routing table not including the subscriber corresponding to the to-be-sent subject.

In a fourth aspect, the embodiments of the present disclosure provide an apparatus for processing information, including: a data set acquisition unit, configured to sort historical data according to a preset data type to obtain at least one data set, the historical data being from a same edge computing device, including to-be-processed historical data and historical result data corresponding to the to-be-processed historical data; a data processing model training unit, configured to train, for a data set in the at least one data set, to obtain a data processing model corresponding to the data set based on historical data in the data set, and the data processing model being used to represent a corresponding relationship between to-be-processed historical data included in the historical data and historical result data corresponding to the to-be-processed historical data in the data set; and a data processing model sending unit, configured to send the data processing model to the edge computing device corresponding to the historical data.

In some embodiments, the apparatus further includes: a to-be-sent subject receiving unit, configured to receive a to-be-sent subject, where the to-be-sent subject is generated by the data processing model on the edge computing device; and a second sending unit, configured to send the to-be-sent subject to a subscriber according to a cloud subject subscription routing table, where the cloud subject subscription routing table is used to record a subscriber address subscribing to the to-be-sent subject.

In a fifth aspect, the embodiments of the present disclosure provide a server, including: one or more processors; and a storage apparatus, storing one or more programs thereon, and the one or more programs, when executed by the one or more processors, cause the one or more processors to implement the method for processing information of the first aspect or the method for processing information of the second aspect.

In a sixth aspect, the embodiments of the present disclosure provide a computer readable medium, storing a computer program thereon, the computer program, when executed by a processor, implements the method for processing information of the first aspect or the method for processing information of the second aspect.

The method and apparatus for processing information provided by the embodiments of the present disclosure first filter a target subject from received subjects according to a preset data type, then perform data processing on the target subject using a data processing model to obtain a to-be-sent subject, and finally send the to-be-sent subject to a subscriber according to a local subject subscription routing table, implementing local processing of the target subject of the preset data type, reducing the network data transmission amount and the cloud data processing amount, and improving the data processing efficiency.

### BRIEF DESCRIPTION OF THE DRAWINGS

After reading detailed descriptions of non-limiting embodiments with reference to the following accompanying drawings, other features, objectives and advantages of the present disclosure will become more apparent:

FIG. 1 is a system architecture diagram to which an embodiment of the present disclosure may be applied;

FIG. 2 is a flowchart of an embodiment of a method for processing information according to the present disclosure;

FIG. 3 is a flowchart of another embodiment of the method for processing information according to the present disclosure;

FIG. 4 is a schematic diagram of an application scenario of the method for processing information according to an embodiment of the present disclosure;

FIG. 5 is a schematic structural diagram of an embodiment of an apparatus for processing information according to the present disclosure; and

FIG. 6 is a schematic structural diagram of a computer system adapted to implement a server of the embodiments of the present disclosure.

FIG. 7 is a schematic structural diagram of a computer system, according to some embodiments.

### DETAILED DESCRIPTION OF EMBODIMENTS

The present disclosure will be further described below in detail in combination with the accompanying drawings and the embodiments. It may be appreciated that the specific embodiments described herein are merely used for explaining the relevant disclosure, rather than limiting the disclosure. In addition, it should be noted that, for the convenience of description, only the parts related to the relevant disclosure are shown in the accompanying drawings.

It should be noted that the embodiments in the present disclosure and the features in the embodiments may be combined with each other on a non-conflict basis. The present disclosure will be described below in detail with reference to the accompanying drawings and in combination with the embodiments.

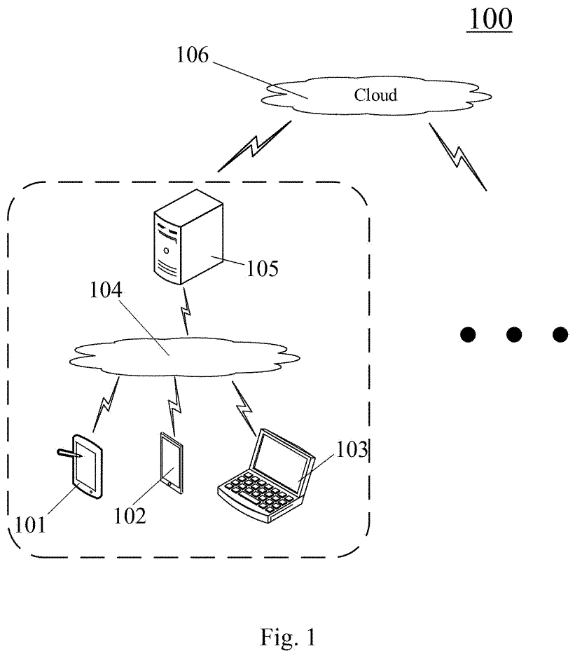

FIG. 1 illustrates a system architecture 100 to which a method for processing information or an apparatus for processing information of the embodiments of the present disclosure may be applied.

As shown in FIG. 1, the system architecture 100 may include terminal devices 101, 102, 103, a network 104, an edge computing device 105, and cloud 106. The network 104 is configured to provide a communication link medium between the terminal devices 101, 102, 103 and the edge computing device 105. The edge computing device 105 performs data interaction with the cloud 106 over a network such as a wide area network. Here, the network 104 may include various types of connections, such as wired, wireless communication links, or optical fibers.

A user may interact with the edge computing device 105 over the network 104 using the terminal devices 101, 102, 103 to receive or send subjects and the like. Various communication client applications, such as a web browser application, a shopping application, a search application, an instant communication tool, a mailbox client, and a social platform software, may be installed on the terminal devices 101, 102, and 103.

The terminal devices 101, 102 and 103 may be hardware or software. When the terminal devices 101, 102 and 103 are hardware, they may be various electronic devices having a display screen and supporting information transmission, including but not limited to smart phones, tablets, e-book readers, laptop portable computers, and desktop computers. When the terminal devices 101, 102 and 103 are software, they may be installed in the above-listed electronic devices. It may be implemented as a plurality of software or software modules (e.g., for providing distributed services) or as a single software or software module, which is not specifically limited in the present disclosure.

The edge computing device 105 may be a server that provides various services, such as receiving a subject sent by the terminal devices 101, 102, and 103 (the publisher of the subject), and forwarding the subject to a server of other terminal devices 101, 102, 103 (subscriber of the subject) that subscribes to the subject. The server may receive the subject sent by the publisher end, query the subscriber that subscribes to the subject according to a subject subscription routing table, and then send the subject to the subscriber.

The cloud 106 may be a network that provides cloud computing. The cloud 106 may connect a plurality of local area networks composed of the terminal devices 101, 102, 103, the network 104 and the edge computing device 105 through the network, and receive data sent by the local area networks. The cloud 106 may send a cloud-computed data processing result to the edge computing device 105 in the corresponding local area network. The cloud 106 may also, for a data processing type of each local area network, train a data processing model for this local area network, so that the edge computing device 105 within the local area network processes the corresponding data in the local area network using the data processing model.

It should be noted that the method for processing information provided by the embodiments of the present disclosure may be performed by the edge computing device 105 alone or may be performed jointly by the edge computing device 105 and the cloud 106. Generally, the method for processing information is performed by the edge computing device 105. Accordingly, the apparatus for processing information may be provided in the edge computing device 105 or may be disposed in the cloud 106.

When the edge computing device 105 and the cloud 106 are hardware, they may be implemented as a distributed device cluster composed of multiple servers or multiple clouds, or may be implemented as a single device. When the edge computing device 105 and the cloud 106 are software, they may be implemented as multiple software or software modules (for example, for providing distributed services), or may be implemented as a single software or software module, which is not specifically limited in the present disclosure.

It should be understood that the number of terminal devices, networks, edge computing devices and clouds in FIG. 1 is merely illustrative. Depending on the implementation needs, there may be any number of terminal devices, networks, edge computing devices and clouds.

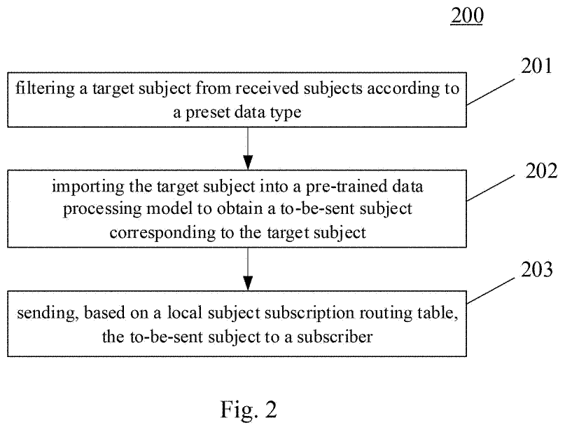

With further reference to FIG. 2, a flow 200 of an embodiment of a method for processing information according to the present disclosure is illustrated. The method for processing information includes the following steps:

Step 201, filtering a target subject from received subject according to a preset data type.

In the present embodiment, the executing body of the method for processing information (for example, the edge computing device 105 as shown in FIG. 1) may receive a subject from a terminal with which the user sends the subject through a wired connection or a wireless connection. The subject may be electronic information of a certain subject sent by the publishing end to the executing body. For example, the subject may be a multimedia message, and the electronic information sent by the publishing end may include the name of the multimedia message, the content of the multimedia message (music or image), and the like. It should be noted that the above wireless connection may include but is not limited to 3G/4G connection, WiFi connection, Bluetooth connection, WiMAX connection, Zigbee connection, UWB (ultra wideband) connection, and other wireless connections that are now known or to-be-developed in the future.

Typically, after the publishing end sends the subject to the edge computing device, the subscriber may subscribe to the subject on the edge computing device. When the subject needs to be data-processed, the edge computing device may send the subject to the cloud through the network. After receiving the subject sent by the edge computing device, the cloud performs cloud computing on the subject, and sends the calculation result of the cloud computing to the corresponding edge computing device. After receiving the calculation result, the edge computing device sends the calculation result to the corresponding subscriber to implement the delivery of the subject. Usually, the cloud may receive a large amount of to-be-processed subject. Each piece of subject needs to go through layers of networks to reach the cloud. It not only increases the risk of data leakage, but also increases the amount of data transmitted by the network and the amount of data processed in the cloud. In this way, the data transmission efficiency of the network and the data processing efficiency of the cloud are improved.

To this end, in some embodiments of the present disclosure, the cloud 106 may analyze historical data of different edge computing devices 105, and perform targeted related data processing on the subject received by the edge computing device 105, sent to the edge computing device 105 by the terminal devices 101, 102, 103 in the local area network where the edge computing device 105 is located. That is, the cloud 106 may perform targeted processing for certain types of data received by the edge computing device 105. For example, it may be that the edge computing device 105 has the hardware advantage of processing certain data. At this point, the cloud 106 may pass some data to the edge computing device 105 for processing to improve the data processing efficiency.

The executing body of some embodiments of the present disclosure receives various types of subject sent by the terminal devices 101, 102, and 103. Then, the executing body may filter a target subject from received subject according to a preset data type. Here, the preset data type may be a video data type, an image data type, or an audio data type. Typically, the preset data type may be selected as subject having a large amount of data (for example, may be a data amount larger than 200 megabytes), or subject that the edge computing device 105 itself may process. The preset data type may also be determined according to actual needs, which is not specifically limited in the present disclosure.

Step 202, importing the target subject into a pre-trained data processing model to obtain a to-be-sent subject corresponding to the target subject.

In order to reduce the data processing pressure of the cloud 106, fully utilize the data processing capability of the edge computing device 105, and improving the data processing efficiency of the edge computing device 105 to the network in which it is located, the cloud 106 of some embodiments of the present disclosure may train a corresponding data processing model based on the preset data type. The data processing model may be obtained by training by the cloud based on historical data of a current edge computing device corresponding to the preset data type, used for representing a corresponding relationship between to-be-processed historical data included in the historical data and historical result data corresponding to the to-be-processed historical data. The historical data includes the to-be-processed historical data and the historical result data corresponding to the to-be-processed historical data. The to-be-processed historical data may be a to-be-processed subject received by the cloud 106. The historical result data may be a to-be-sent subject obtained by the cloud 106 after performing cloud computing on the to-be-processed historical data.

According to actual needs, when the cloud 106 needs the edge computing device 105 to process data of another non-current edge computing devices 105, a data processing model may be obtained by training by the historical data sent by the another edge computing device 105 or the network to the cloud 106, and the data processing model is passed to the current edge computing device 105 so that the current edge computing device 105 processes the corresponding subject.

In some alternative implementations of the present embodiment, the method may include:

In the first step, setting an input address of the data processing model as a receiving address of the target subject.

After the cloud 106 trains to complete the data processing model, the data processing model may be sent to the corresponding edge computing device 105. The edge computing device 105 may implement local processing of the target subject of the preset data type using the data processing model, thereby improving data processing efficiency. Before acquiring the data processing model, the edge computing device 105 needs to send the target subject to the cloud 106 and send the data sent by the cloud 106 to the corresponding subscriber. After acquiring the data processing model, the routing information of the target subject for querying information needs to be modified, so that the data processing model on the edge computing device 105 completes the data processing of the target subject. To this end, the edge computing device 105 may set the input address of the data processing model as the receiving address of the target subject.

In the second step, setting an output address of the data processing model as a sending address of the to-be-sent subject.

The data processing model performs data processing on the target subject to obtain the to-be-sent subject. In order to achieve the transmission of data, the edge computing device 105 may set the output address of the data processing model as the sending address of the to-be-sent subject. In this way, the input address and the output address of the data processing model are set.

In some alternative implementations of the present embodiment, the importing the target subject into a pre-trained data processing model may include the following steps:

In the first step, querying, in the local subject subscription routing table, primary routing information between a publishing address corresponding to the target subject and the input address of the data processing model.

A local subject subscription routing table is stored on the edge computing device 105 of some embodiments of the present disclosure. The local subject subscription routing table may be used to record the publishing address and the subscription address corresponding to the target subject. After the input address of the data processing model is set as the receiving address of the target subject, the edge computing device 105 may query, in the local subject subscription routing table, primary routing information between the publishing address corresponding to the target subject and the input address of the data processing model. The primary routing information may be used to represent the path to send the target subject to the input address of the data processing model.

In the second step, sending the target subject from the publishing address to an input end of the data processing model based on the primary routing information.

After the primary routing information is determined, the edge computing device 105 may send the target subject from the publishing address to the input end of the data processing model based on the primary routing information. Then, the data processing model may perform corresponding data processing on the target subject.

Step 203, sending the to-be-sent subject to a subscriber according to a local subject subscription routing table.

After the data processing model performs corresponding data processing on the target subject, the corresponding to-be-sent subject may be obtained. Here, the to-be-sent subject is the information that needs to be sent to the subscriber.

In some alternative implementations of the present embodiment, the sending the to-be-sent subject to a subscriber according to a local subject subscription routing table may include:

In the first step, querying, in response to the data processing model obtaining the to-be-sent subject, a subscription address of the target subject corresponding to the to-be-sent subject.

Since the subscribers that subscribe to the target subject are usually different, after the data processing model obtains the to-be-sent subject, it needs to re-determine the receiving address of each piece of the to-be-sent subject. The to-be-sent subject is obtained by performing data processing on the target subject by the data processing model. The subscription address of the target subject is the receiving address of the to-be-sent subject.

In the second step, querying, in the local subject subscription routing table, secondary routing information corresponding to an output address of the data processing model and the subscription address; and

Similar to the acquiring the primary routing information, the edge computing device 105 may query, in the local subject subscription routing table, secondary routing information corresponding to the output address of the data processing model and the subscription address. The secondary routing information may be used to represent the path to send the to-be-sent subject to the subscription address.

In the third step, sending the to-be-sent subject from an output end of the data processing model to the subscriber based on the secondary routing information.

After the secondary routing information is determined, the edge computing device 105 may send the to-be-sent subject from the output end of the data processing model to the subscriber based on the secondary routing information. The edge computing device 105 completes local processing of the target subject using the data processing model.

In some alternative implementations of the present embodiment, the sending the to-be-sent subject to a subscriber according to a local subject subscription routing table may further include: sending the to-be-sent subject to the cloud, in response to the local subject subscription routing table not including the subscriber corresponding to the to-be-sent subject.

In the network structure shown in FIG. 1, the subject sent from one local area network to the cloud 106 may need to be sent to another local area network. When the edge computing device 105 in a certain local area network obtains to-be-sent subject using the data processing model, and the edge computing device 105 cannot find the subscriber corresponding to the to-be-sent subject, the subscriber corresponding to the to-be-sent subject is not in the current local area network. To this end, the edge computing device 105 may send the above-mentioned to-be-sent subject to the cloud 106. The cloud 106 further determines the subscriber of the to-be-sent subject according to the stored cloud subject subscription routing table, thereby implementing the end cloud (the edge computing device and the cloud) integrated processing data, fully utilizing the data processing capability of the edge computing device 105, reducing the data processing pressure of the cloud 106, and improving the data processing efficiency.

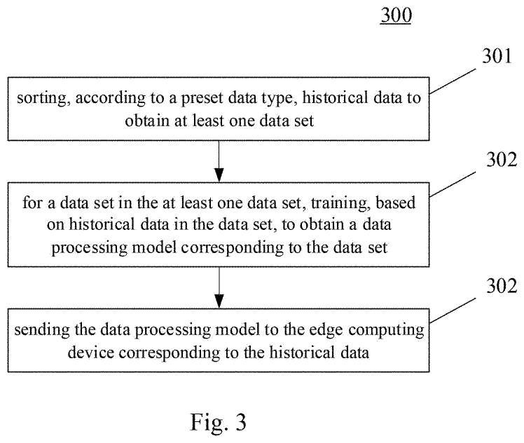

With further reference to FIG. 3, a flow 300 of another embodiment of the method for processing information according to the present disclosure is shown. The method for processing information includes the following steps:

Step 301, sorting historical data according to a preset data type, to obtain at least one data set.

In the present embodiment, the executing body of the method for processing information (for example, the cloud 106 as shown in FIG. 1) may acquire historical data of the edge computing device 105 through a wired connection or a wireless connection. It should be noted that the above wireless connection may include but is not limited to 3G/4G connection, WiFi connection, Bluetooth connection, WiMAX connection, Zigbee connection, UWB (ultra wideband) connection, and other wireless connections that are now known or to-be-developed in the future.

In order to reduce the data processing pressure on the cloud 106 and improve the utilization of the data processing capability of the edge computing device 105, the executing body of the present embodiment may sort the historical data according to a preset data type, to obtain at least one data set. In this way, each data set contains historical data of the same type. Generally, the local area network where each edge computing device 105 is located has its own data characteristics, and the cloud 106 may divide the historical data according to the edge computing device 105. The historical data may include to-be-processed historical data and historical result data corresponding to the to-be-processed historical data. In the present embodiment, the preset data type may be a video data type, an image data type, or an audio data type. Typically, the preset data type may be selected as subject itself having a large data amount (for example, may be a data amount larger than 200 megabytes), or subject that the edge computing device 105 itself may process. For a specific edge computing device 105, the preset data types may be different, which may be determined according to actual needs, and detailed description thereof will be omitted.

Step 302, training, for a data set in the at least one data set, to obtain a data processing model corresponding to the data set based on historical data in the data set.

For each data set, the cloud 106 may train to obtain the corresponding data processing model based on the historical data contained in the data set. The to-be-processed historical data may be the to-be-processed subject received by the cloud 106. The historical result data may be the to-be-sent subject obtained by the cloud 106 after performing cloud computing on the to-be-processed historical data.

When training the data processing model, the cloud 106 may use the to-be-processed historical data included in the historical data as an input of the data processing model, and use the historical result data included in the historical data as an output of the data processing model to train to obtain the data processing model. The data processing model may be used to represent a corresponding relationship between the to-be-processed historical data included in the historical data and the historical result data corresponding to the to-be-processed historical data in the data set.

Step 303, sending the data processing model to the edge computing device corresponding to the historical data.

Typically, the data processing model may exist in the form of data (or data packet, program, etc.). After obtaining the data processing model, the cloud 106 may send the data processing model to the edge computing device corresponding to the historical data.

In some alternative implementations of the present embodiment, the method may further include the following steps:

In the first step, receiving to-be-sent subject.

In the network structure shown in FIG. 1, the subject sent from one local area network to the cloud 106 may need to be sent to another local area network. When the edge computing device 105 in a certain local area network obtains to-be-sent subject using the data processing model, and the edge computing device 105 cannot find the subscriber corresponding to the to-be-sent subject, it means the subscriber corresponding to the to-be-sent subject is not in the current local area network. To this end, the edge computing device 105 may send the above-mentioned to-be-sent subject information may be generated by the data processing model on the edge computing device.

In the second step, sending the to-be-sent subject to a subscriber according to a cloud subject subscription routing table.

In the present embodiment, the cloud subject subscription routing table may be used to record a subscriber address subscribing to the to-be-sent subject. The cloud 106 may determine the subscriber of the to-be-sent subject sent by the edge computing device 105 according to the stored cloud subject subscription routing table, thereby implementing the end cloud (the edge computing device and the cloud) integratedly processing data, fully utilizing the data processing capability of the edge computing device 105, reducing the data processing pressure of the cloud 106, and improving the data processing efficiency.

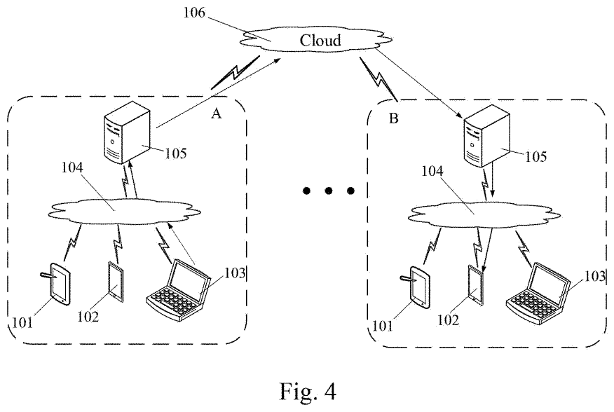

With further reference to FIG. 4, FIG. 4 is a schematic diagram of an application scenario of the method for processing information according to the present embodiment. In the application scenario of FIG. 4, the cloud 106 sends the data processing model to the edge computing device 105 in the network A. The terminal device 103 in the network A sends a subject to the edge computing device 105 in the network A. The subscriber of the subject is the terminal device 102 in the network B. The edge computing device 105 in the network A filters, based on the data type, and determines the subject as the target subject processed by the data processing model. Then, the edge computing device 105 in the network A performs data processing on the target subject using the data processing model thereon to obtain a to-be-sent subject. Finally, the edge computing device 105 in the network A sends the to-be-sent subject to the cloud 106. The cloud 106 receives the to-be-sent subject sent by the edge computing device 105 in the network A, and sends the to-be-sent subject to the terminal device 102 in the network B according to a cloud subject subscription routing table. The data transmission process is shown by the arrow in FIG. 4.

The method for processing information provided by the above embodiments of the present disclosure first filters a target subject from received subjects according to a preset data type, then performs data processing on the target subject using a data processing model to obtain a to-be-sent subject, and finally sends the to-be-sent subject to a subscriber according to a local subject subscription routing table, implementing local processing of the target subject of the preset data type, reducing the network data transmission amount and the cloud data processing amount, and improving the data processing efficiency.

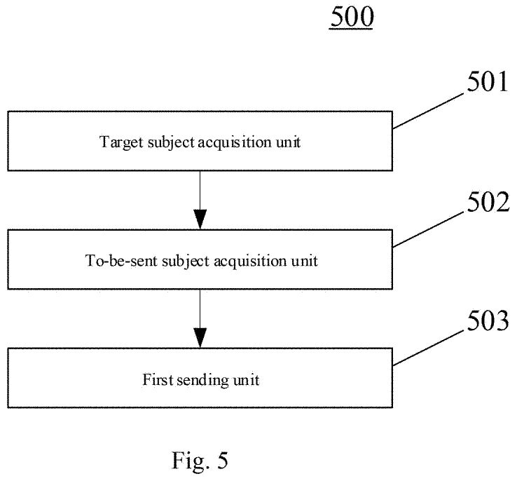

With further reference to FIG. 5, as an implementation of the method shown in the above figures, the present disclosure provides an embodiment of an apparatus for processing information, and the apparatus embodiment corresponds to the method embodiment as shown in FIG. 2, and the apparatus may be specifically applied to various electronic devices.

As shown in FIG. 5, the apparatus 500 for processing information of the present embodiment includes: a target subject acquisition unit 501, a to-be-sent subject acquisition unit 502 and a first sending unit 503. The target subject acquisition unit 501 is configured to filter a target subject from received subjects according to a preset data type. The to-be-sent subject acquisition unit 502 is configured to import the target subject into a pre-trained data processing model to obtain a to-be-sent subject corresponding to the target subject, the data processing model being obtained by training by a cloud based on historical data of a current edge computing device corresponding to the preset data type, for representing a corresponding relationship between to-be-processed historical data included in the historical data and historical result data corresponding to the to-be-processed historical data, and the historical data including the to-be-processed historical data and the historical result data corresponding to the to-be-processed historical data. The first sending unit 503 is configured to send the to-be-sent subject to a subscriber according to a local subject subscription routing table.

In some alternative implementations of the present embodiment, the apparatus 500 for processing information may further include: a first address setting unit (not shown in the figure) and a second address setting unit (not shown in the figure). The first address setting unit is configured to set an input end address of the data processing model as a receiving address of the target subject; and the second address setting unit is configured to set an output end address of the data processing model as a sending address of the to-be-sent subject.

In some alternative implementations of the present embodiment, the to-be-sent subject acquisition unit 502 may include: a primary routing information querying subunit (not shown in the figure) and a first information sending subunit (not shown in the figure). The primary routing information querying subunit is configured to query, in the local subject subscription routing table, primary routing information between a publisher address corresponding to the target subject and the input end address of the data processing model, where the local subject subscription routing table is for recording the publisher address and a subscriber address corresponding to the target subject. The first information sending subunit is configured to send the target subject from the publisher address to an input end of the data processing model based on the primary routing information.

In some alternative implementations of the present embodiment, the first sending subunit 503 may include: a subscriber address querying subunit (not shown in the figure), a secondary routing information querying subunit (not shown in the figure) and a second information sending subunit (not shown in the figure). The subscriber address querying subunit is configured to query, in response to the data processing model obtaining the to-be-sent subject, a subscriber address of the target subject corresponding to the to-be-sent subject. The secondary routing information querying subunit is configured to query, in the local subject subscription routing table, secondary routing information corresponding to an output end address of the data processing model and the subscriber address. The second information sending subunit is configured to send the to-be-sent subject from an output end of the data processing model to the subscriber based on the secondary routing information.

In some alternative implementations of the present embodiment, the first sending unit 503 may further include: a third information sending subunit (not shown in the figure), configured to send the to-be-sent subject to the cloud, in response to the local subject subscription routing table not including the subscriber corresponding to the to-be-sent subject.

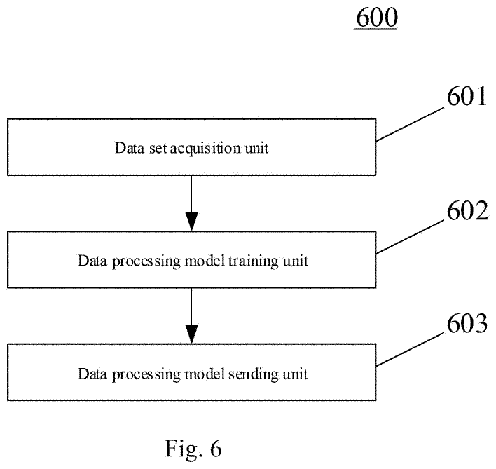

With further reference to FIG. 6, as an implementation of the method shown in the above figures, the present disclosure provides an embodiment of an apparatus for processing information, and the apparatus embodiment corresponds to the method embodiment as shown in FIG. 3, and the apparatus may be specifically applied to various electronic devices.

As shown in FIG. 6, the apparatus 600 for processing information of the present embodiment may include: a data set acquisition unit 601, a data processing model training unit 602 and a data processing model sending unit 603. Here, the data set acquisition unit 601 is configured to sort historical data according to a preset data type to obtain at least one data set, the historical data being from a same edge computing device, including to-be-processed historical data and historical result data corresponding to the to-be-processed historical data. The data processing model training unit 602 is configured to train, for a data set in the at least one data set, to obtain a data processing model corresponding to the data set based on historical data in the data set, and the data processing model being used to represent a corresponding relationship between to-be-processed historical data included in the historical data and historical result data corresponding to the to-be-processed historical data in the data set. The data processing model sending unit 603 is configured to send the data processing model to the edge computing device corresponding to the historical data.

In some alternative implementations of the present embodiment, the apparatus 600 for processing information may further include: a to-be-sent subject receiving unit (not shown in the figure) and a second sending unit (not shown in the figure). The to-be-sent subject receiving unit is configured to receive a to-be-sent subject, where the to-be-sent subject is generated by the data processing model on the edge computing device. The second sending unit is configured to send the to-be-sent subject to a subscriber according to a cloud subject subscription routing table, where the cloud subject subscription routing table is used to record a subscriber address subscribing to the to-be-sent subject.

The present embodiment further provides a server, including: one or more processors; and a storage apparatus, storing one or more programs thereon, and the one or more programs, when executed by the one or more processors, cause the one or more processors to implement the method for processing information.

The present embodiment further provides a computer readable medium, storing a computer program thereon, the computer program, when executed by a processor, implements the method for processing information.

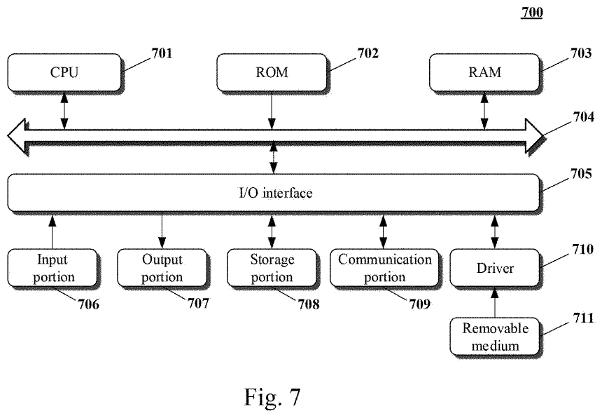

With further reference to FIG. 7, a schematic structural diagram of a computer system 700 adapted to implement a server (for example, the edge computing device 105 in FIG. 1) of the embodiments of the present disclosure is shown. The server shown in FIG. 7 is merely an example, and should not limit the function and scope of use of the embodiments of the present disclosure.

As shown in FIG. 7, the computer system 700 includes a central processing unit (CPU) 701, which may execute various appropriate actions and processes in accordance with a program stored in a read-only memory (ROM) 702 or a program loaded into a random access memory (RAM) 703 from a storage portion 708. The RAM 703 also stores various programs and data required by operations of the system 700. The CPU 701, the ROM 702 and the RAM 703 are connected to each other through a bus 704. An input/output (I/O) interface 705 is also connected to the bus 704.

The following components are connected to the I/O interface 705: an input portion 706 including a keyboard, a mouse, etc.; an output portion 707 including such as a cathode ray tube (CRT), a liquid crystal display device (LCD), a speaker, etc.; a storage portion 708 including a hard disk and the like; and a communication portion 709 including a network interface card, such as a LAN card and a modem. The communication portion 709 performs communication processes via a network, such as the Internet. A driver 710 is also connected to the I/O interface 705 as required. A removable medium 711, such as a magnetic disk, an optical disk, a magneto-optical disk, and a semiconductor memory, may be installed on the driver 710, to facilitate the retrieval of a computer program from the removable medium 711, and the installation thereof on the storage portion 708 as needed.

In particular, according to the embodiments of the present disclosure, the process described above with reference to the flow chart may be implemented as a computer software program. For example, an embodiment of the present disclosure includes a computer program product, which includes a computer program that is tangibly embedded in a computer-readable medium. The computer program includes program codes for performing the method as illustrated in the flow chart. In such an embodiment, the computer program may be downloaded and installed from a network via the communication portion 709, and/or may be installed from the removable medium 711. The computer program, when executed by the central processing unit (CPU) 701, implements the above mentioned functionalities as defined by the method of some embodiments of the present disclosure.

It should be noted that the computer readable medium in some embodiments of the present disclosure may be computer readable signal medium or computer readable storage medium or any combination of the above two. An example of the computer readable storage medium may include, but not limited to: electric, magnetic, optical, electromagnetic, infrared, or semiconductor systems, apparatus, elements, or a combination of any of the above. A more specific example of the computer readable storage medium may include but is not limited to: electrical connection with one or more wire, a portable computer disk, a hard disk, a random access memory (RAM), a read only memory (ROM), an erasable programmable read only memory (EPROM or flash memory), a fiber, a portable compact disk read only memory (CD-ROM), an optical memory, a magnet memory or any suitable combination of the above. In some embodiments of the present disclosure, the computer readable storage medium may be any physical medium containing or storing programs which may be used by a command execution system, apparatus or element or incorporated thereto. In some embodiments of the present disclosure, the computer readable signal medium may include data signal in the base band or propagating as parts of a carrier, in which computer readable program codes are carried. The propagating data signal may take various forms, including but not limited to: an electromagnetic signal, an optical signal or any suitable combination of the above. The signal medium that can be read by computer may be any computer readable medium except for the computer readable storage medium. The computer readable medium is capable of transmitting, propagating or transferring programs for use by, or used in combination with, a command execution system, apparatus or element. The program codes contained on the computer readable medium may be transmitted with any suitable medium including but not limited to: wireless, wired, optical cable, RF medium etc., or any suitable combination of the above.

The flow charts and block diagrams in the accompanying drawings illustrate architectures, functions and operations that may be implemented according to the systems, methods and computer program products of the various embodiments of the present disclosure. In this regard, each of the blocks in the flow charts or block diagrams may represent a module, a program segment, or a code portion, said module, program segment, or code portion including one or more executable instructions for implementing specified logic functions. It should also be noted that, in some alternative implementations, the functions denoted by the blocks may occur in a sequence different from the sequences shown in the accompanying drawings. For example, any two blocks presented in succession may be executed, substantially in parallel, or they may sometimes be in a reverse sequence, depending on the function involved. It should also be noted that each block in the block diagrams and/or flow charts as well as a combination of blocks may be implemented using a dedicated hardware-based system performing specified functions or operations, or by a combination of a dedicated hardware and computer instructions.

The units involved in the embodiments of the present disclosure may be implemented by means of software or hardware. The described units may also be provided in a processor, for example, described as: a processor, including a target subject acquisition unit, a to-be-sent subject acquisition unit and a first sending unit. Here, the names of these units do not in some cases constitute a limitation to such units themselves. For example, the first sending unit may also be described as “a unit for sending the to-be-sent subject to a subscriber according to a local subject subscription routing table.”

In another aspect, the present disclosure further provides a computer readable medium. The computer readable medium may be included in the apparatus in the above described embodiments, or a stand-alone computer readable medium not assembled into the apparatus. The computer readable medium stores one or more programs. The one or more programs, when executed by the apparatus, cause the apparatus to: filter a target subject from received subject according to a preset data type; import the target subject into a pre-trained data processing model to obtain a to-be-sent subject corresponding to the target subject, the data processing model being obtained by training by cloud based on historical data of a current edge computing device corresponding to the preset data type, used for representing a corresponding relationship between to-be-processed historical data included in the historical data and historical result data corresponding to the to-be-processed historical data, and the historical data including the to-be-processed historical data and the historical result data corresponding to the to-be-processed historical data; and send the to-be-sent subject to a subscriber according to a local subject subscription routing table.

The above description only provides an explanation of the preferred embodiments of the present disclosure and the technical principles used. It should be appreciated by those skilled in the art that the inventive scope of the present disclosure is not limited to the technical solutions formed by the particular combinations of the above-described technical features. The inventive scope should also cover other technical solutions formed by any combinations of the above-described technical features or equivalent features thereof without departing from the concept of the present disclosure. Technical schemes formed by the above-described features being interchanged with, but not limited to, technical features with similar functions disclosed in the present disclosure are examples.

What is claimed is:

1. A method for processing information, the method comprising:
filtering a target subject from received subjects according to a preset data type;
importing the target subject into a pre-trained data processing model to obtain a to-be-sent subject corresponding to the target subject, the data processing model being obtained by training by a cloud based on historical data of a current edge computing device corresponding to the preset data type, for representing a corresponding relationship between to-be-processed historical data comprised in the historical data and historical result data corresponding to the to-be-processed historical data, and the historical data comprising the to-be-processed historical data and the historical result data corresponding to the to-be-processed historical data; and
sending the to-be-sent subject to a subscriber according to a local subject subscription routing table,
wherein the method is performed by at least one hardware processor.

2. The method according to claim 1, wherein the method further comprises:
setting an input end address of the data processing model as a receiving address of the target subject; and
setting an output end address of the data processing model as a sending address of the to-be-sent subject.

3. The method according to claim 2, wherein the importing the target subject into a pre-trained data processing model comprises:
querying, in the local subject subscription routing table, primary routing information between a publisher address corresponding to the target subject and the input end address of the data processing model, wherein the local subject subscription routing table is for recording the publisher address and a subscriber address corresponding to the target subject; and
sending the target subject from the publisher address to an input end of the data processing model based on the primary routing information.

4. The method according to claim 2, wherein the sending the to-be-sent subject to a subscriber according to a local subject subscription routing table comprises:
querying, in response to the data processing model obtaining the to-be-sent subject, a subscriber address of the target subject corresponding to the to-be-sent subject;
querying, in the local subject subscription routing table, secondary routing information corresponding to an output end address of the data processing model and the subscriber address; and
sending the to-be-sent subject from an output end of the data processing model to the subscriber based on the secondary routing information.

5. The method according to claim 1, wherein the sending the to-be-sent subject to a subscriber according to a local subject subscription routing table further comprises:
sending the to-be-sent subject to the cloud, in response to the local subject subscription routing table not including the subscriber corresponding to the to-be-sent subject.

6. A method for processing information, the method comprising:
sorting historical data according to a preset data type to obtain at least one data set, the historical data being from a same edge computing device, comprising to-be-processed historical data and historical result data corresponding to the to-be-processed historical data;
training, for a data set in the at least one data set, to obtain a data processing model corresponding to the data set based on historical data in the data set, and the data processing model being used to represent a corresponding relationship between to-be-processed historical data comprised in the historical data and historical result data corresponding to the to-be-processed historical data in the data set; and
sending the data processing model to the edge computing device corresponding to the historical data,
wherein the method is performed by at least one hardware processor.

7. The method according to claim 6, wherein the method further comprises:
receiving a to-be-sent subject, wherein the to-be-sent subject is generated by the data processing model on the edge computing device; and
sending the to-be-sent subject to a subscriber according to a cloud subject subscription routing table, wherein the cloud subject subscription routing table is used to record a subscriber address subscribing to the to-be-sent subject.

8. An apparatus for processing information, the apparatus comprising:
at least one processor; and
a memory storing instructions, the instructions when executed by the at least one processor, cause the at least one processor to perform operations, the operations comprising:
filtering a target subject from received subjects according to a preset data type;
importing the target subject into a pre-trained data processing model to obtain a to-be-sent subject corresponding to the target subject, the data processing model being obtained by training by a cloud based on historical data of a current edge computing device corresponding to the preset data type, for representing a corresponding relationship between to-be-processed historical data comprised in the historical data and historical result data corresponding to the to-be-processed historical data, and the historical data comprising the to-be-processed historical data and the historical result data corresponding to the to-be-processed historical data; and
sending the to-be-sent subject to a subscriber according to a local subject subscription routing table.

9. The apparatus according to claim 8, wherein the operations further comprise:
setting an input end address of the data processing model as a receiving address of the target subject; and
setting an output end address of the data processing model as a sending address of the to-be-sent subject.

10. The apparatus according to claim 9, wherein the importing the target subject into a pre-trained data processing model comprises:
querying, in the local subject subscription routing table, primary routing information between a publisher address corresponding to the target subject and the input end address of the data processing model, wherein the local subject subscription routing table is for recording the publisher address and a subscriber address corresponding to the target subject; and
sending the target subject from the publisher address to an input end of the data processing model based on the primary routing information.

11. The apparatus according to claim 9, wherein the sending the to-be-sent subject to a subscriber according to a local subject subscription routing table comprises:
querying, in response to the data processing model obtaining the to-be-sent subject, a subscriber address of the target subject corresponding to the to-be-sent subject;
querying, in the local subject subscription routing table, secondary routing information corresponding to an output end address of the data processing model and the subscriber address; and
sending the to-be-sent subject from an output end of the data processing model to the subscriber based on the secondary routing information.

12. The apparatus according to claim 8, wherein the sending the to-be-sent subject to a subscriber according to a local subject subscription routing table further comprises:
sending the to-be-sent subject to the cloud, in response to the local subject subscription routing table not including the subscriber corresponding to the to-be-sent subject.

13. An apparatus for processing information, the apparatus comprising:
at least one processor; and
a memory storing instructions, the instructions when executed by the at least one processor, cause the at least one processor to perform the method of claim 6.

14. The apparatus according to claim 13, wherein the operations further comprise:
receiving a to-be-sent subject, wherein the to-be-sent subject is generated by the data processing model on the edge computing device; and
sending the to-be-sent subject to a subscriber according to a cloud subject subscription routing table, wherein the cloud subject subscription routing table is used to record a subscriber address subscribing to the to-be-sent subject.

15. A non-transitory computer readable storage medium storing a computer program, wherein the computer program, when executed by a processor, causes the processor to perform the method of claim 1.

16. A non-transitory computer readable storage medium storing a computer program, wherein the computer program, when executed by a processor, causes the processor to perform the method of claim 6.
